(19) United States
(12) Patent Application Publication
(10) Pub. No.: US 2009/0290818 A1
(43) Pub. Date: Nov. 26, 2009

(54) Cover Strip for a Linear Guide Rail

(76) Inventor: Tsung-Jen Chen, Taichung Industrial Park (TW)

Correspondence Address: Dr. BANGER SHIA, 102 Lindencrest Ct., Sugar Land, TX, 77479-5201, US

(21) Appl. No.: 12/126,981

(22) Filed: May 26, 2008

(51) Int. Cl. F16C 29/08

(52) U.S. Cl. 384/15

(57) ABSTRACT

A cover strip for a linear guide rail, wherein a slide block is slidably disposed on the guide rail, a cover strip covers an upper surface of the guide rail, each of two sides of the guide rail extend outwards to form an extending surface with large slope, and each extending surface extends downward to form a flange, two sides of the central portion of the cover strip are provided with extending portions, and each extending portion extends downwards to form an engaging portion, the structures extending from two sides of the cover strip are configured in the shape of the corresponding structures of the guide rail, and a free end of each engaging portion extends downward to cover the ridge of each flange in such a manner that the cover strip can be positioned on the guide rail assuredly and stably.

### BACKGROUND OF THE INVENTION

1. Field of the Invention

The present invention relates to a cover strip for a linear guide rail, and more particularly to a cover strip applied onto an upper surface of a linear guide rail, which can be engaged to the guide rail more assuredly and conveniently and has the advantages such as better dustproof effect and lower cost.

2. Description of the Prior Art

In order to improve the dustproof effect, guide rails for the linear guideways are each provided with a cover strip on the upper surface thereof. The existing guide rails, as disclosed in U.S. Pat. No. 6,012,846, U.S. Pat. No. 6,502,988, U.S. Pat. No. 6,629,779, U.S. Pat. No. 6,749,338, etc are each formed with an elongated groove in the upper surface thereof, and the cover strip is fixed to two inner sides of the groove. Such a design has the following disadvantages:

1. The cost is increased due to the formation of the elongated groove;

2. Dust or dirt can still accumulate at the joint between the cover strip and the groove, so the dustproof effect is poor;

3. In a high temperature or lower temperature environment, or an environment where the temperature difference is great, the coefficient of thermal expansion and cold contraction of the cover strip is far larger than that of the groove of the guide rail, and the cover trip is clamped by the groove, so it is more likely to cause deformation and disengagement of the cover strip.

Further in U.S. Pat. No. 6,592,261, the guide rail is formed with a groove recessed towards the center thereof, and has two side surfaces continuous to the upper surface through round portions, the cover strip includes a central portion covering the upper surface of the guide rail and two edge portions in the axial direction of the guide rail. Each edge portion includes an intermediate section, a front end section and a base section, the intermediate section of the edge portion is engaged with the undercut portion of the guide rail, and the base section is curved outward from the intermediate section so as to coincide in shape with the round portion of the guide rail, the front end is bent outward from the intermediate section so as to be opened outwards. Such a design has the following disadvantages:

1Two sides of the cover strip are bent outward, so the resulting sharp portion is likely to cut the scraping sheet, affecting the sealing and dustproof function.

2. The intermediate section of the cover strip is engaged with the undercut portion of the guide rail via a round portion, so the cover strip and the guide rail are required to both have very high geometrical precision, causing a much higher manufacturing cost.

In addition, as disclosed in U.S. Pat. No. 5,575,566 and JPB 2719985, the guide rail has an undercut in each of two side faces thereof, and the cover strip has a center section covering the upper surface of the guide rail, and two edge sections extending in the axial direction of the guide rail and bent off inward at a sharp angle from the central section for engagement with the side faces of the guide rail, the cover strip is made of a hardened spring material. However, such a design has the following disadvantages:

1. Dirt or dust may possibly collect at the undercut and then penetrates into the interior of the slide block.

2. The angle between the center section and the respective edge section of the cover strip is smaller than 90°, when the cover strip is frequently assembled and disassembled, the edge sections is likely to cause the plastic deformation, losing the effect of engagement with the guide rail.

In U.S. Pat. No. 7,229,213, the guide rail has on two side surfaces thereof a track recess with a track surface formed thereon, and the upper track surface of the track recess is a slope gradually diminishing in a width direction of the rail downwardly from the upper side surface, the cover strip includes a side edge portion with an engagement portion, the engagement portion of the cover strip is engaged with the upper track surface. This design has the disadvantages such as: the angle between the side edge portion and the center portion of the cover strip is 90°, and the side edge is likely to cause plastic deformation due to frequent assembly and disassembly, losing the effect of engagement with guide rail.

The present invention has arisen to mitigate and/or obviate the afore-described disadvantages.

### SUMMARY OF THE INVENTION

The primary objective of the present invention is to provide a cover strip for a linear guide rail, wherein the cover strip is slantways guided along two sides of the guide rail to flanges and extends downward to cover ridges of the flanges to make the cover strip fully cover an upper surface and two side edges of the guide rail, so as to achieve the best dustproof effect.

The second objective of the present invention is to provide a cover strip for a linear guide rail, wherein two sides of the cover strip are engaged with the bottom edges of the flanges of the guide rail in such a manner that the cover strip is assuredly positioned to the flanges at two sides of the guide rail, so that the cover strip is unnecessary to have high precision but can be assuredly positioned on the slide rail, greatly reducing the manufacturing cost.

Another objective of the present invention is to provide a cover strip for a linear guide rail, wherein two sides of the cover strip bend inward to engage with the bottoms of the flanges at two sides of the guide rail in such a manner that the sharp portions of the free ends of the cover strip cannot be exposed to cut objectives or personals, thus offering high safety.

Another objective of the present invention is to provide a cover strip for a linear guide rail, wherein the cover strip has two extending portions at two sides thereof, and the angle between the respective extending portion and the central portion is greater than 90°, so that the structure body of the cover strip bends at an angle not more than 90°, thus avoiding the problem of stress concentration, increasing strength and effectively extending service life.

### BRIEF DESCRIPTION OF THE DRAWINGS

FIG. 1 is a perspective view of a cover strip for a linear guide rail in accordance with the present invention;

FIG. 2 is a cross-sectional view of a fitting configuration of the cover strip and the guide rail in accordance with the present invention;

FIG. 3 is a partial cross-sectional view of the fitting configuration of the cover strip and the guide rail in accordance with the present invention;

FIG. 4 is an enlarged plane view of one end of the cover strip in accordance with the present invention;

FIG. 5 is a schematic view showing how the cover strip is fitted on the guide rail in accordance with the present invention; and

FIG. 6 is a plane view of another cover strip for a linear guide rail in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

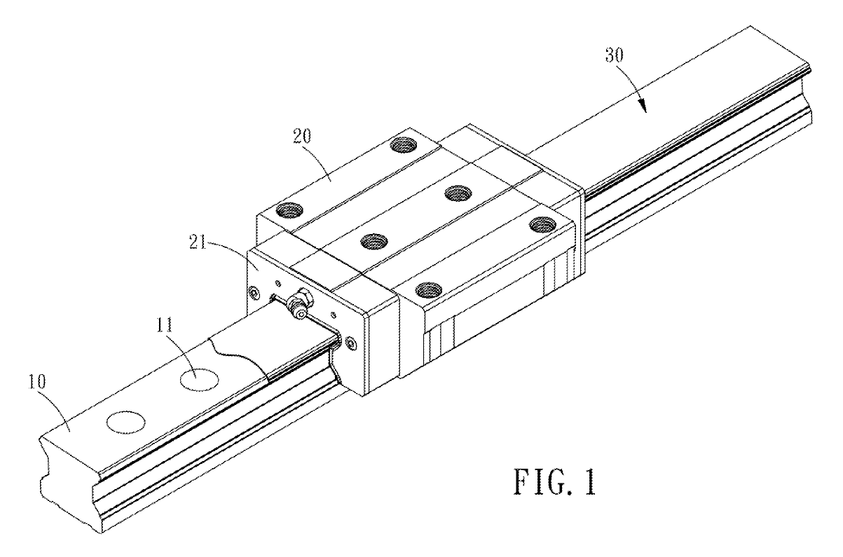

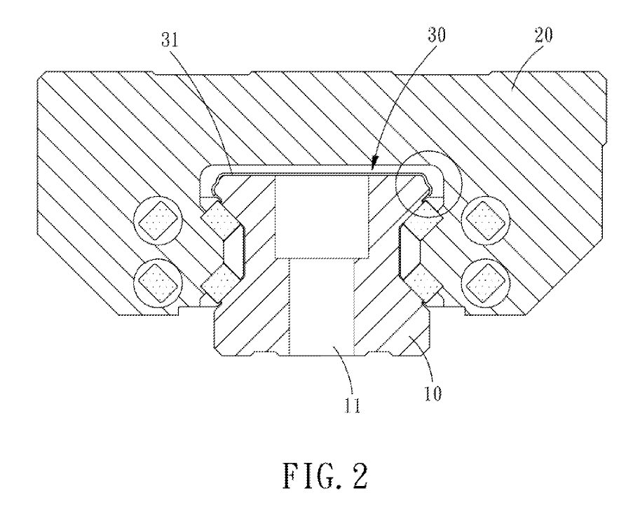

Referring to FIGS. 1-4, a slide block 20 is slidably mounted on a guide rail 10, and the guide rail 10 is provided with a plurality of bolt mounting holes 11 for insertion of bolts to fix the guide rail to a machine or other positions. The slide block 20 is provided on two ends thereof with two scraping plates 21. A cover strip 13 covers an upper surface 12 of the guide rail 10. Plural rolling elements 40 are interposed between the slide block 20 and the guide rail 10 and connected together by a retainer 41. The present invention is characterized in that, the entire cover strip 30 is configured according to the guide rail 10 and to have a predetermined engaging force for reinforcing the engagement between the cover strip 30 and the guide rail 10, so as to achieve the objectives such as high stability, high dustproof effect, high safety and lower cost.

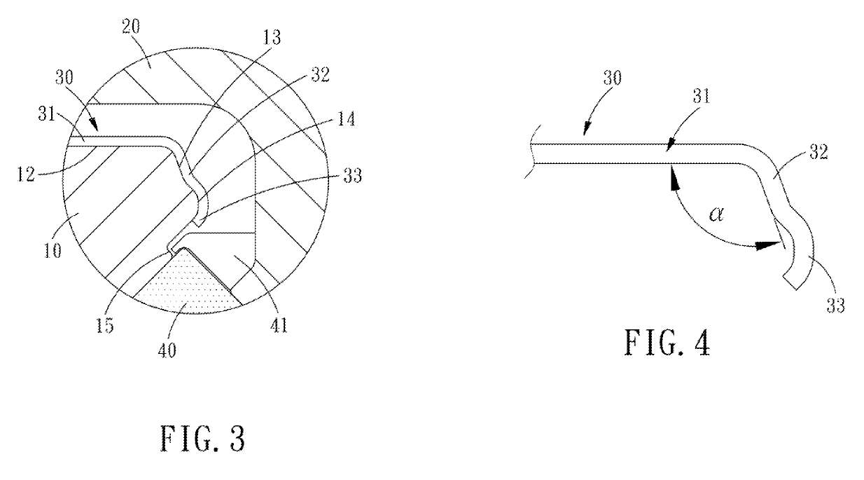

Each of two sides of the upper surface 12 of the guide rail 10 extends downwards and outwards to form an extending surface 13 in the shape of an oblique arc. As shown in FIG. 3, each extending surface 13 extends outwards and downwards to form a convex flange 14, and a flat inclined elongated groove 15 is further formed at the bottom of the flange 14.

The cover strip 30 includes a flat central portion 31 covering the upper surface 12 of the guide rail 10, as shown in FIG. 4. The cover strip 30 is formed of a plate member, and each of two sides of the central portion 31 extends along the extending surface 13 of the guide rail 10 to form an extending portion 32 which ensures that the upper surface 12 of the guide rail 10 are fully covered, and the angle a between the respective extending portion 32 and the central portion 31 is greater than 90° to form an obtuse angle.

Extending downward from each extending portion 32 is an engaging portion 33 formed in the shape of the flange 14 for covering it, and the engaging portion 33 further extends downward to cover the ridge of each flange 14 and then slightly bends inward to form a hook-shaped or a spoon-shaped structure, so as to engage the engaging portion 33 with the bottom of the flange 14 substantially.

The inner bottom of each groove 15 of the guide rail 10 is provided for accommodation of ends of the retainer 41 outside the rolling elements 40.

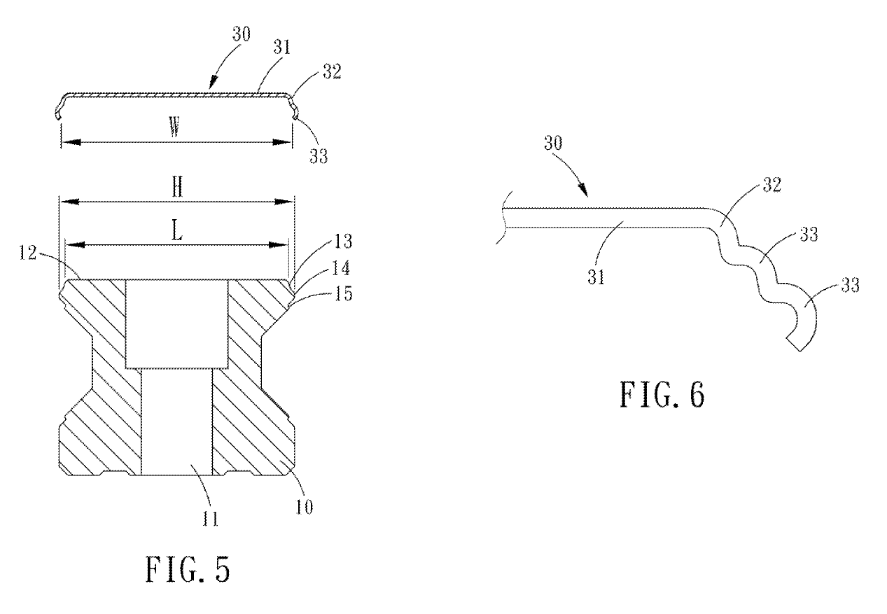

Further referring to FIG. 5, the distance W between the lower ends of the engaging portions 33 at two sides of the cover strip 30 is greater than the width L of the upper surface 12 of the guide rail 10 and smaller than the distance H between the ridges of the flanges 14 at two sides of the guide rail 10. The profile of engaging portion 33 is similar to that of the flange 14 of the guide rail 10 in such a manner that the engaging portions 33 can be engaged with and the flanges 14.

Further referring to FIG. 6 which shows another embodiment of the present invention, the cover strip 30 can have continuous engaging portions 33 according to the shape of the guide rail 10. Such arrangements can also achieve the above functions.

The cover strip 30 of the present invention can achieve the following functions and objectives:

1. High dustproof effect: the engaging portions 33 of the cover strip 30 are assuredly engaged with the flanges 14 of the guide rail 10 to fix the cover strip 30 on the upper surface 12 of the guide rail 10, so that the large-area upper surface 12 and the side edge related structures, such as the bolt mounting holes 11, the structures protruding from the side edges and the structures under the side edges are fully covered by the cover strip 30, and the dust or dirt can be prevented from collecting on the upper surface 12 and the side surfaces of the guide rail 10, thus assuredly preventing dust to have a high dustproof effect..

2. Fine positioning effect and lower cost: the cover strip 30 is positioned on the guide rail 10 by elastic engagement of the flanges 14 with the engaging portions, so the structure precision of other part of the cover strip 30 can be lowered relatively, thus reducing the manufacturing cost of the cover strip 30.

3. High strength and having an elastic predetermined force: with the obtuse angle between the central portion 31 and the extending portion 32 of the cover strip 30, the stress concentration can be reduced to effectively increase strength, and the bending structure has an elastic predetermined force in such a manner that the engaging portions 33 can apply elastic engaging force to the flanges, thus improving the position stability.

4. High safety: the engaging portion 33 extends downward to cover the ridge of each flange 14 and toward the groove 15 in such a manner that the free end of the engaging portion bends inwards and downwards, ensuring the sharp freed end not to contact people or objects other than the guide rail 10 or not to cause the unnecessary damage, particularly the position where the scraping plate 21 contacts the guide rail 10 not to be damaged by the end of each engaging portion 33 of the cover strip 30.

While we have shown and described various embodiments in accordance with the present invention, it is clear to those skilled in the art that further embodiments may be made without departing from the scope of the present invention.

What is claimed is:

1. A cover strip for a linear guide rail comprising:
a guide rail being provided with at least one flange at each of two sides thereof, each flange protruding outwards from a side surface of the guide rail;
a slide block being slidably disposed on the guide rail, and plural rolling elements being interposed between the slide block and the guide rail; and
a cover strip including a central portion covering an upper surface of the guide rail, two sides of the central portion of the cover strip bending outwards and then extending to form two extending portions, an angle between the respective extending portion and the central portion being an obtuse angle, each extending portion extending from the side surface of the guide rail to an exterior of the flange of the guide rail to form an engaging portion which extends downward to cover a ridge of each flange.

2. The cover strip for a linear guide rail as claimed in claim 1, wherein the side surfaces of the guide rail are extending surfaces extending downwards and outwards from two sides of the upper surface of the guide rail, each extending surface extends downwards and outwards to form a convex flange, a flat inclined groove is formed at a bottom of each flange, the rolling elements are connected to one another by a retainer with ends extending into the groove.

3. The cover strip for a linear guide rail as claimed in claim 1, wherein each extending portion of the cover strip bends toward the exterior of each flange to form a spoon-shaped engaging portion, which extends downward to cover the ridge of each flange and then bends inward.

4. The cover strip for a linear guide rail as claimed in claim 1, wherein a distance between lower ends of the engaging portions at two sides of the cover strip is greater than a width of the upper surface of the guide rail and smaller than a distance between the ridges of the flanges at two sides of the guide rail.

5. A cover strip for a linear guide rail comprising:
a guide rail being provided with at least one flange at each of two sides thereof, each flange protruding outwards from a side surface of the guide rail;
a slide block being slidably disposed on the guide rail, and plural rolling elements being interposed between the slide block and the guide rail; and
a cover strip including a central portion covering an upper surface of the guide rail, two sides of the central portion bending outwards and then extending to form two extending portion, an angle between the respective extending portion and the central portion being an obtuse angle, each extending portion extending from the side surface of the guide rail to an exterior of the flange to form an engaging portion which extends downward to cover a ridge of each flange and then bends inward to form a hook-shaped structure.

6. The cover strip for a linear guide rail as claimed in claim 5, wherein the side surfaces of the guide rail are extending surfaces extending downwards and outwards from two sides of the upper surface of the guide rail, each extending surface extends downwards and outwards to form a convex flange, a flat inclined groove is formed at a bottom of each flange, the rolling elements are connected to one another by a retainer with ends extending into the groove.

7. The cover strip for a linear guide rail as claimed in claim 5, wherein a distance between lower ends of the engaging portions at two sides of the cover strip is greater than a width of the upper surface of the guide rail and smaller than a distance between the ridges of the flanges at two sides of the guide rail.

8. A cover strip for a linear guide rail comprising:
a guide rail being provided with an inclined extending surface at each of two sides thereof, and each extending surface extends downwards to form at least one flange, each flange protruding outwards from a side surface of the guide rail;
a slide block being slidably disposed on the guide rail, and plural rolling elements being interposed between the slide block and the guide rail; and
a cover strip including a central portion covering an upper surface of the guide rail, two sides of the central portion bend outwards to form extending portions, an angle between the respective extending portion and the central portion being an obtuse angle, each extending portion extending from the side surface of the guide rail to an exterior of each flange to form an engaging portion, which extends downward to cover a ridge of each flange.

9. The cover strip for a linear guide rail as claimed in claim 8, wherein a flat inclined groove is formed at a bottom of each flange of the guide rail, the rolling elements are connected to one another by a retainer with ends extending into the groove.

10. The cover strip for a linear guide rail as claimed in claim 8, wherein each extending portion of the cover strip bends towards the exterior of each flange to form a spoon-shaped engaging portion, which extends downward to cover the ridge of each flange and then bends inward.

11. The cover strip for a linear guide rail as claimed in claim 8, wherein a distance between lower ends of the engaging portions at two sides of the cover strip is greater than a width of the upper surface of the guide rail and smaller than a distance between the ridges of the flanges at two sides of the guide rail.
